(19) United States
(12) Patent Application Publication
(10) Pub. No.: US 2008/0180389 A1
(43) Pub. Date: Jul. 31, 2008

(54) Optical-based interconnect for integrated circuits and related system and method

(76) Inventors: Michael Kelly, Queen Creek, AZ (US); Jeffrey P. Tobin, Corvallis, OR (US); William Sission, Corvallis, OR (US); Mark D. Johnson, Corvallis, OR (US)

Correspondence Address: Kathy Manke;Avago Technologies Limited, 4380 Ziegler Road, Fort Collins, CO, 80525, US

(21) Appl. No.: 11/698,448

(22) Filed: Jan. 26, 2007

(51) Int. Cl. G09G 5/00

(52) U.S. Cl. 345/156

(57) ABSTRACT

An interconnect for connecting an integrated circuit to an optical interface subsystem includes a first optical transmitter disposed in the integrated circuit and operable to transmit light signals to the optical interface subsystem, a first optical receiver disposed in the optical interface subsystem and operable to receive light signals from the first optical transmitter, a second optical transmitter disposed in the optical interface subsystem and operable to transmit light signals to the integrated circuit, and a second optical receiver disposed in the integrated circuit and operable to receive light signals from the second optical transmitter.

### BACKGROUND

Recently, technologies have emerged for providing high-density electrical interconnections between an integrated circuit (IC) chip and a substrate to form IC assemblies, otherwise known as IC packages. An IC package is used to electrically couple an IC chip (or die) to external components and circuitry. Common technologies for forming electrical connections between an IC die and a substrate include wire bonding and flip-chip bonding.

Wire bonding is achieved by fabricating an IC die having metal bonding pads along its periphery. These peripheral pads serve as terminals for wires to connect the IC die to the substrate.

However, wire bonding has several disadvantages. First, the bonding pads are relatively large and typically occupy up to 40% of the die area. This is because there must be enough space on each pad to bond the wire to the pad and to provide an adequate placement tolerance. In addition, electrostatic discharge (ESD) circuitry is typically required for each pad, and this circuitry takes up a significant amount of die area beneath the pad. Therefore, the pad is typically as large as the area that the ESD circuitry occupies. Second, because only the periphery of the die is used for the large bonding pads, the number of such pads for a given sized die is limited. Third, because the wires connect the bonding pads from the periphery of the die to bonding pads on the substrate in an area (typically a peripheral area of the substrate) not occupied by the die, a relatively large surface area of the substrate is used. Fourth, the wires used to connect the die to the substrate introduce additional inductance and resistance that can degrade the signal quality of the IC package. And fifth, the reliability of the wire-bond connections may be adversely affected by temperature cycles. This is because the metal wires and bonding pads often have different coefficients of expansion than the non-metal die, substrate, and encapsulating material. As a result, during heat cycles, these materials may deform at different rates and place a significant amount of physical stress (and potentially cause damage) on the wire-bond connections.

Flip-chip bonding is achieved by fabricating an IC die having an array of metal bonding pads that align with a corresponding array of metal bonding pads on the substrate. Before assembly onto the substrate, solder bumps are deposited on the pads of the die. The die is then “flipped” upside down and placed on the surface of the substrate so that the solder bumps of the die are in alignment with the bonding pads of the substrate. All connections between the die and the substrate are then made simultaneously by heating the solder bumps to a reflow temperature at which the solder melts and an electrical interconnect is formed between the bonding pads of the die and the substrate.

However, flip-chip bonding also has several disadvantages. First, the cost of flip-chip bonding is significantly higher than the cost of wire bonding. Second, the solder used in flip-chip bonding may cause alpha particle contamination. Alpha particles emitted from the solder are capable of generating electron/hole pairs that may cause soft errors in some components. And third, the solder is typically made from environmentally unfriendly materials such as lead.

### SUMMARY

An embodiment includes provision for interconnection of an electronic system and an integrated circuit using an optical interface for one or more of the connections. An embodiment of an interconnect may include a first optical transmitter and first optical receiver disposed in an optical interface subsystem operatively coupled respectively to a second optical receiver and second optical transmitter disposed in an integrated circuit. One or more of the optical transmitters may comprise an organic light-emitting diode. The interconnect may optionally include one or more conducted signal paths.

### BRIEF DESCRIPTION OF THE DRAWINGS

FIG. 1 is a block diagram of some principal components an electronic system having an optically-coupled integrated circuit according to an embodiment.

FIG. 2 is a partial cross-sectional diagram of an optical interface to an integrated circuit having a continuous light transmissive layer according to an embodiment.

FIG. 3 is a partial cross-sectional diagram of an optical interface to an integrated circuit having a mask for isolating optical data channels according to an embodiment.

FIG. 4 is a partial cross-sectional diagram of an optical interface having adaptive data channel alignment according to an embodiment.

FIG. 5 is a partial cross-sectional diagram of an optical interface to an integrated circuit having a discontinuous light transmissive layer according to an embodiment.

FIG. 6 is a simplified perspective view of an embodiment of an image sensor array having an optical interface.

### DETAILED DESCRIPTION

The following discussion is presented to enable a person skilled in the art to make and use embodiments of the invention. Various modifications to the preferred embodiment will be readily apparent to those skilled in the art, and the generic principles herein may be applied to other embodiments and applications without departing from the spirit and scope of the invention. Thus, the scope is not intended to be limited to the embodiments shown, but is to be accorded the widest scope consistent with the principles and features disclosed herein.

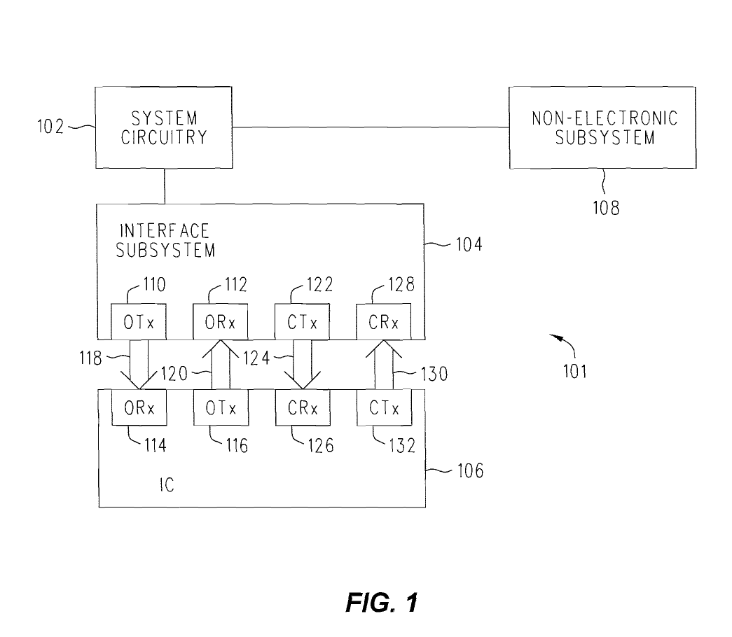

FIG. 1 is a functional block diagram of an electronic system 101 including system circuitry 102, an interface subsystem 104 operatively coupled to the system circuitry, and an integrated circuit (IC) 106 having an optical interface operatively coupled to an optical interface of the interface subsystem. The electronic system 101 may further include one or more non-electronic subsystems 108. Non-electronic subsystems 108 may, for example, include mechanical, optical, network, or fluidic components.

The system circuitry 102 may be operable to generate a first data signal. The first data signal may include one or more of several types of data including for example an address, an integer value, a floating point value, a query, a system tick, etc. The first data signal may optionally be converted to another form by the system circuitry and transmitted to the interface subsystem 104, or alternatively may be transmitted to the interface subsystem in its original form. The interface subsystem 104 may optionally convert the received first data signal or the converted signal to another form.

The interface subsystem 104 includes at least one optical transmitter 110 or one optical receiver 112 configured to respectively transmit and receive optical signals to and from the IC 106. The IC 106 includes a corresponding at least one optical receiver 114 or a corresponding at least one optical transmitter 116 operable to respectively receive and transmit optical signals from and to the interface subsystem 104. Specifically, the optical transmitter 110 disposed on the interface subsystem 104 may be driven to emit a first optical signal 118 corresponding to a first data signal for receipt by the optical receiver 114 disposed on the IC 106; and the optical transmitter 116 disposed on the IC may be driven to emit a second optical signal 120 corresponding to a second data signal for receipt by the optical receiver 112 disposed on the interface subsystem.

According to an embodiment, the interface subsystem 104 may include a conducted signal transmitter 122 operable to transmit a conducted signal 124 to a corresponding conducted signal receiver 126 disposed on the IC 106. Similarly, the interface subsystem 104 may include a conducted signal receiver 128 operable to receive a conducted signal 130 from a conducted signal transmitter 132 disposed on the IC 106. The functionality of the conducted signal transmitter 122 and conducted signal receiver 128 of the interface subsystem 104 may optionally be combined as a bi-directional conducted signal transceiver operable to send and receive conducted signals to and from a corresponding combined conducted signal transceiver comprising a similarly combined bidirectional conducted signal transmitter 132 and conducted signal receiver 126 disposed on the IC 106. The conducted signal communication apparatuses may for example be embodied as simple conductive pads configured for connections via wire bonds, flip chip bump connections, conductive adhesive connections, anisotropically conductive adhesive portions, etc.

The interface subsystem 104 may exist as a discrete element or alternatively may be integrated into one or more elements of the system circuitry. For example, the interface subsystem 104 may include a chip carrier configured for mounting on a printed circuit board. Alternatively, the interface subsystem may be configured to be operatively coupled to a system using an interface standard such as, for example, USB, Firewire, IEEE 1284, PCI, PCMCIA (PC Card), SmartMedia, Compact Flash, MMC, SD, SCSI, IRdA, Bluetooth, Zigbee, IEEE 802.11, Ethernet, Fibre Channel, etc. The interface subsystem 104 may include an IC package substrate, a printed circuit board (PCB), an IC arranged for use in a stacked die configuration with the IC 106, or other assembly.

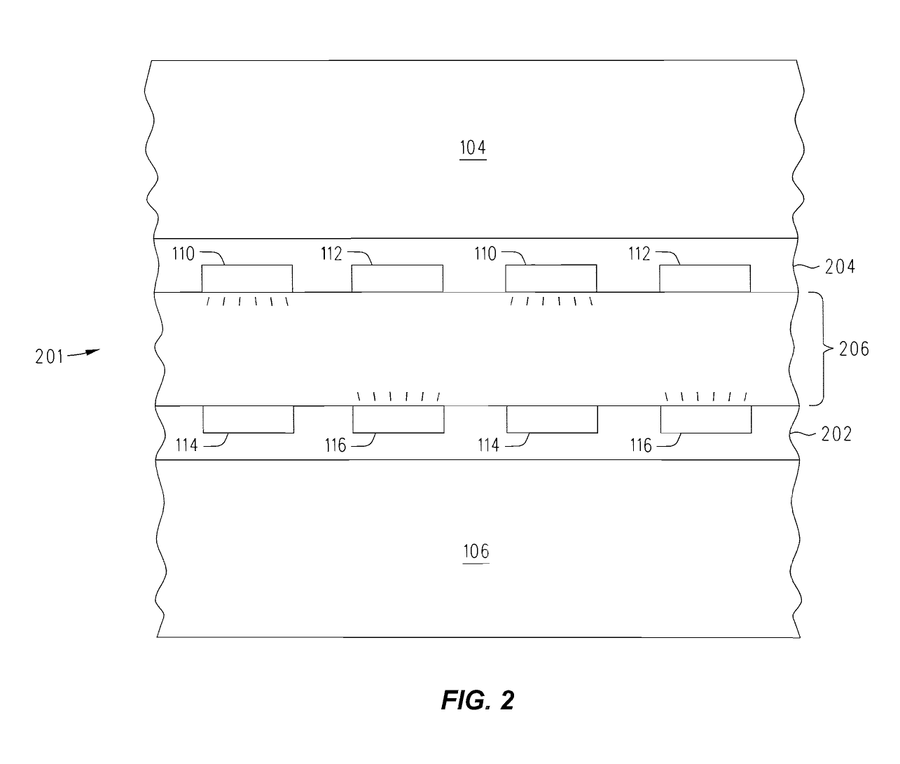

FIG. 2 is a partial cross-sectional diagram showing a physical relationship of an interface 201 between an interface subsystem 104 and an IC having an optical interface 106, according to an embodiment. The interface 201 provides signal connections between an IC including the optical interface 106 and the interface subsystem 104.

The interface 201 includes a first optical transceiver layer 202 on the IC 106, a second optical transceiver layer 204 on the interface subsystem 104, and an optically- or light-transmissive layer 206 between the first and second optical transceiver layers. Each of the first 202 and second 204 optical transceiver layers includes an array of optical transmitters, 116 and 110, respectively; and optical receivers, 114 and 112, respectively. The optical transmitters 116 of the first transceiver layer 202 may be optically aligned in registration with the corresponding optical receivers 112 of the second transceiver layer 204, and the optical transmitters 110 of the second transceiver layer 204 may optically aligned in registration with the corresponding optical receivers 114 of the first transceiver layer 202. In this way, optical signals may be transmitted from the optical transmitters 110, 116 to corresponding optical receivers 114, 112 through the light-transmissive layer 206.

According to an embodiment, the optical transmitters 110, 116 may be organic light-emitting-diodes (OLEDS) and the optical receivers 112, 114 may be organic photo diodes (OPDs), for example made from the same or similar organic materials as the OLEDs. For example, OLEDs may be small-molecule or polymeric-based.

OPDs or OLEDs may, for example, be based on polled organic chromophores that may exhibit non-linear optical properties. Polled organic chromophores may respond to impinging light by transferring charge from one end, for example an electron donor end nominally having a negative charge; across a conductive, conjugated bridge, for example alternating C—C single and C═C double bonds; to a second end, for example an electron receiver end nominally having a positive charge. The resonance structures of the polled chromophores may allow them to readily respond to applied charges (for example, resulting in modification of their associated index of refraction) or to applied light (resulting in charge separation or migration, as described above). The structure and synthesis of organic chromophores may be found in U.S. Pat. No. 6,716,995; entitled Design and Synthesis of Advanced NLO Materials for Electro-Optic Applications; invented by Huang, et al., and incorporated herein by reference.

Electromagnetic radiation signals propagate through the light-transmissive layer 206, with light signals propagating from the optical transmitters 110, 116 to the optical receivers 114, 112, respectively. According to one embodiment, the light-transmissive layer 206 may be an air gap or other fluid gap. According to another embodiment, the light-transmissive layer 206 may comprise a gel or solid material such as a light-transmissive polymer. According to another embodiment, the light-transmissive layer 206 may comprise an optical adhesive such as a UV-curable adhesive that is configured to provide mechanical stabilization in addition to providing an electromagnetic propagation medium. For embodiments where the light-transmissive layer 206 comprises an adhesive, the optical transmitters 110, 116 may be brought into proper optical alignment with their respective receivers 114, 112 during assembly, and held there while the adhesive is cured. As will be explained below, other approaches may be used in alternative embodiments.

According to an embodiment, the size of the optical transmitters 110, 116 and the optical receivers 112, 114 may be much smaller than the bonding pads used in other technologies. With optical connections between the optical transmitters 110, 116 and optical receivers 112, 114; the signal paths on the IC 106 may be electrically isolated from the optical interface subsystem 104. As a result, electrostatic discharge (ESD) may become less of an issue; and the use of ESD circuitry associated with each connection point may no longer be required in the IC 106 (and possibly the optical interface subsystem 104). Since ESD circuitry may normally occupy a relatively large footprint, its elimination may allow smaller size of the interface elements 114, 116 and optionally tighter pitch between. In addition, because the optical coupling does not necessarily require metal signal wires or bonds, the materials of the interface 201 may be selected to have coefficients of thermal expansion that are more compatible with the coefficients of thermal expansion of other materials (e.g., silicon) comprising the IC 106 and optical interface subsystem 104. Alternatively or additionally, the materials used in the light-transmissive layer 206 may be selected to provide mechanical compliance. As a result, less physical stress is placed on the signal connections during temperature cycles, and the reliability of the signal connections may be increased.

In the case of a unidirectional signal connection between the IC 106 and the optical interface subsystem 104, a single optical transmitter 110, 116 and/or a single optical receiver 112, 114 may be used. For example, if the IC 106 receives a signal from the optical interface subsystem 104, an optical receiver 114 is formed in the first optical transceiver layer 202, an optical transmitter 110 is formed in the second optical transceiver layer 204, and the transmitter/receiver pair are brought into optical alignment with one another. Similarly, a unidirectional interface from the IC 106 to the interface subsystem 104 may be made by forming an optical transmitter 116 in the first optical transceiver layer 202, forming an optical receiver 112 in the second optical transceiver layer 204, and bringing the transmitter/receiver pair into optical alignment with one another across the light-transmissive layer or optical transmission medium 206.

In the case of a bidirectional signal connection between the IC 106 and the optical interface subsystem 104, a total of two optical transmitters 110, 116 and two optical receivers 114, 112 may be used for each signal path. According to an embodiment, instead of having a single bidirectional bonding pad that is connected to an input/output circuit formed in a conventional IC, the input/output circuit is effectively eliminated and a separate input optical receiver 114 and output optical transmitter 116 may be used. Similarly, for bidirectional transmission to and from the optical interface subsystem 104, an optical transmitter 110 and optical receiver 112 may be formed respectively in the second optical transceiver layer 204. It should be noted that although two transmitter/receiver pairs may replace what was formerly a single bidirectional pad, the combined size of the optical transmitters 110, 116 and optical receivers 114, 112 may be smaller than a bonding pad, as discussed above. As a result, the combined area occupied by the optical transmitter 110, 116 and optical receiver 112, 114 may still be smaller than the area occupied by the conventional bidirectional pad.

Alternatively, a single bidirectional interface may be used between the optical transceiver layer 202 and underlying IC circuitry instead of separate input and output signal paths. An input/output buffer or other switching circuitry may be formed in the first optical transceiver layer 202 in addition to an optical receiver 114 and an optical transmitter 116. The switching circuit selects the optical receiver 114 for input signals and the optical transmitter 116 for output signals, and routes the signals as appropriate to the bidirectional interface in the IC 106. Similarly, switching circuitry may be formed in the interface subsystem 104 including, according to an embodiment, in the second optical transceiver layer 204. The switch circuit selects the optical receiver 112 for input signals and the optical transmitter 110 for output signals, and routes the signals as appropriate to a bidirectional trace in the system circuitry 102 (shown in FIG. 1).

The first 202 and second 204 optical transceiver layers may be formed respectively on the surface of the IC 106 and the optical interface subsystem 104 in a number of ways. For example, the optical transceiver layers 202 and 204 may be formed using conventional pattern and etch technology that is often used to form various layers of an integrated circuit. Alternatively, the optical transceiver layers 202 and 204 may be formed using an inkjet technology that puts down the layers, for example in a desired pattern such that no subsequent patterning and etching is required. In this alternative, organic materials of the optical transmitters 116 and the optical receivers 114 may be such that these devices are printable using inkjet technology. The power to run the first 202 and second 204 optical transceiver layers may be obtained by connecting each layer as appropriate to corresponding power and ground bonding pads. Because the optical transmitters 110, 116 and the optical receivers 112 may use relatively little power, the addition of the first 202 and second 204 optical transceiver layers may not create a significant increase in power consumption. Moreover, reductions in resistance and/or capacitance associated with conducted interfaces may result in an overall decrease in power consumption.

Each of the first 202 and second 204 optical transceiver layers may be multi-layered, for example if different regions (e.g. —p-region/intrinsic-region/n-region) of the photoreceivers 114, 112; or different regions of the optical transmitters (e.g. OLEDs) are formed in different layers. Alternatively, either of the first 202 and second 204 optical transceiver layers may be a single layer, for example if lateral-type diode junctions are used. In addition, other types of devices (e.g. such as transistors, diodes, resistors, conductors, and/or capacitors) may be formed in the first 202 and/or second 204 optical transceiver layers. Such devices may be used, for example, as switches, buffers, amplifiers, attenuators, drivers, etc.

Once the first 202 and second 204 optical transceiver layers are formed, the IC 106 may be connected to the optical interface subsystem 104 in a number of ways. As discussed above, a light-transmissive layer 204 may be used to optically couple the IC 106 to the optical interface subsystem 104. The light-transmissive layer 204 may be formed of an optical-quality adhesive or glue. Such a layer typically allows the propagation of light signals having a wavelength in the range of about 300-1000 nm, although material that allows propagation of different wavelengths may be used for the layer as well.

As shown in FIG. 2, the optical transmitters 110, 116 and optical receivers 114, 112 may be formed in complementary patterns to align each transmitter with its corresponding receiver. For example, the transmitters 110, 116 may be interdigitated with the receivers 112, 114 as shown. Such an arrangement may be used to group related signals on the die 106, and also to reduce crosstalk between signals. That is, each pair of neighboring transmitters 110 comprising the interface subsystem 104 may be separated from one another by an intermediately-positioned receiver 112. Correspondingly, each pair of neighboring receivers 114 comprising the transceiver layer 202 comprising the IC 106 is spaced apart by an interdigitated transmitter 116. Such an arrangement may help to reduce the incidence of a given optical receiver 114, 112 receiving optical signals from two or more optical transmitters 110, 116; and thus reduce crosstalk.

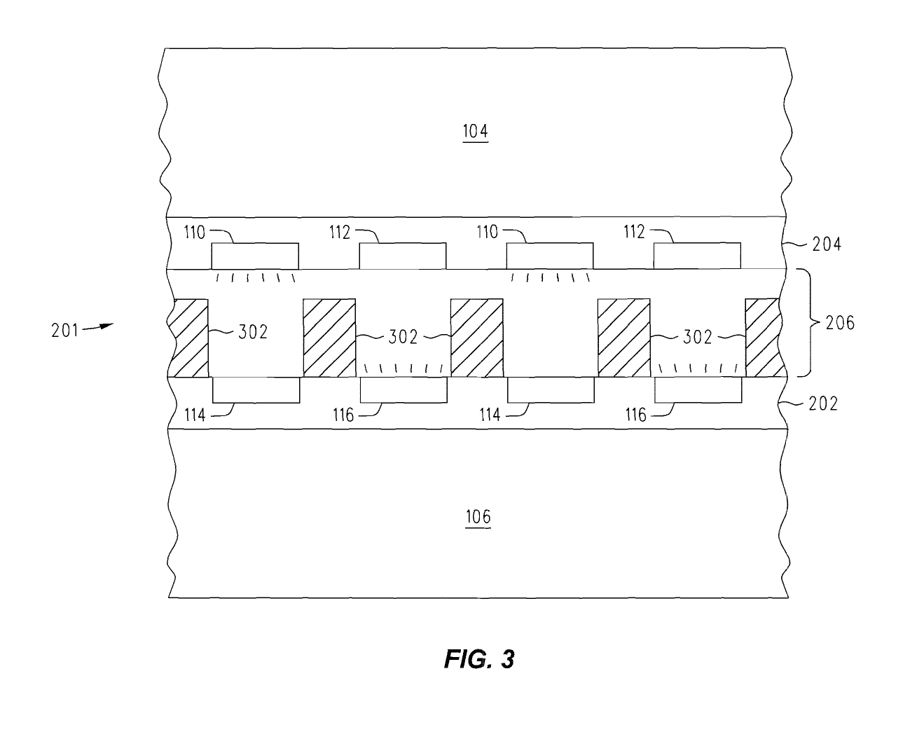

As shown in the embodiment of FIG. 3, an optional optical mask 302 may be placed in the optical transmission layer 206 to reduce the effective numerical aperture of the optical transmitters 110, 116 and optical receivers 114, 112. In other words, the mask 302 may be used to block light from a non-corresponding optical transmitter 110, 116 from reaching a given optical receiver 114, 112. The mask 302 may be formed in a manner akin to a punched gasket, may be printed on one or both transceiver layers 202, 204, may be electro-formed, may be etched, or may be formed using other appropriate technology. According to an embodiment, the optical mask 302 may be formed intrinsically, for example as a result of transmitter and/or detector device geometry.

Alternatively, other approaches may be used to reduce the incidence of signal cross-talk between the transmitter/receiver pairs 110/114, 116/112. For example the first and second data signals may be converted to formats resistant to cross-talk. For example, the signals 118, 120 may be encoded according to a variety of schemas including, optionally, amplitude modulated, frequency modulated, wavelength modulated, phase-shift-key modulated, return-to-zero modulated, non-return-to-zero modulated, half-duplex modulated, full-duplex modulated, and/or spread-spectrum modulated such as direct sequence-spread-spectrum and frequency-hopping-spread-spectrum. Alternatively, the emission wavelengths and sensitivity wavelengths, respectively, of the transmitters 110, 116 and receivers 114, 112 may be selected to reduce the optical coupling between non-corresponding elements. For example wavelength-selective filters may be printed or otherwise formed over the transmitters 110, 116 and corresponding receivers 114, 112.

As indicated above, embodiments discussed have assumed registration or alignment between corresponding optical elements. Optical alignment tolerances may be loosened according to embodiments. For example, a single optical transmitter 110, 116 and a plurality of optical receivers 112, 114 may be formed in their respective layers. Alternatively a single optical receiver and a plurality of optical transmitters may be formed. According to another alternative, plural transmitters and receivers on the interface subsystem 104 may be adaptively programmed according to an actual alignment with corresponding transmitters and receivers on the IC 106.

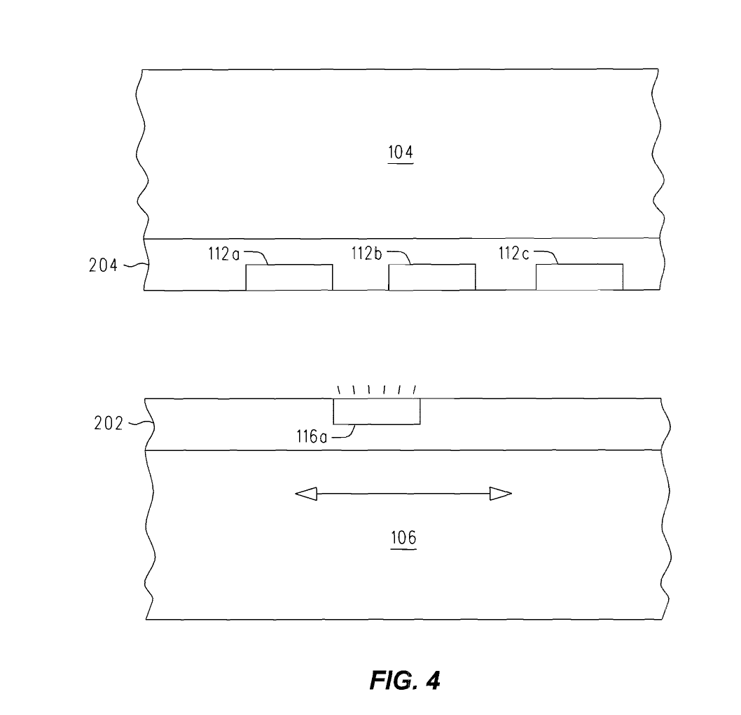

FIG. 4 illustrates, in simplified form, the use of an adaptive interface to select the optical coupling between the interface subsystem 104 and the IC 106. For ease of understanding, it will be assumed that a single unidirectional optical signal is desired. An optical transmitter 116a comprising the optical transceiver layer 202 of the IC 106 is desired to transmit an optical signal to the interface subsystem 104. A plurality of optical receivers 112 may be formed in the transceiver layer 204 comprising the optical interface subsystem 104. In the example, three optical receivers 112a, 112b, and 112c are shown. During assembly, the lateral position of the IC 106 may vary relative to the interface subsystem 104. The system or assembly tooling/testing equipment may enable the optical transmitter 116a while snooping or monitoring for a received signal on data channels corresponding to the three optical receivers 112a-c. According to an embodiment, the IC 106 may be allowed to settle into a physical position and the best (strongest) signal selected to choose one of the three optical receivers 112a, 112b, or 112c for physical connection or assignment of an address corresponding to the unidirectional signal location. According to another embodiment, the manufacturing and test equipment may include an actuator to selectively move the IC to a location corresponding to a desired alignment between the optical transmitter 116 and one of the optical receivers, for example optical receiver 112b.

Of course, the interface may comprise many more data connections than the single unidirectional channel shown. However, the principle may be applied to a great number of parallel channels. In such embodiments, a small number of registration transmitters 116a may be used as dedicated (or multipurpose, i.e. having a data channel designation after leaving the factory) channels for alignment of the IC 106 with the interface subsystem 104. Alternatively, the interface may be implemented as an adaptive interface with, for example, a generic, standardized, or customized interface subsystem being assigned pin-outs or addresses according to the channel optical alignments sensed during assembly and test. Other approaches may similarly be implemented without departing from the spirit and scope disclosed herein.

Referring again to FIG. 1, the interface between the interface subsystem 104 and the IC 106 may include conducted channels in addition to optical channels. A number of approaches may be used according to various embodiments for combining optical and conductive data channels.

According to an embodiment, anisotropically conductive or “z-axis”-conductive adhesive may be used to form conductors between the interface subsystem 104 and the IC 106. According to one embodiment, a layer of optical-quality adhesive similar to or commonly formed with the light-transmissive layer 206 may include z-axis conductive material in spots or throughout. The z-axis conductive material may make electrical continuity between aligned or opposed conductive channels including transmitters/receivers 122/126 and 128/132 but not short-out bonding pads that are not aligned with one another. That is, z-axis conductive material may be used to form the electrical coupling 124 between a conducted signal transmitter 122 contained in the interface subsystem 104 and the corresponding conducted signal receiver 126 contained in the IC 106; and also form the electrical coupling 130 between a conducted signal transmitter 132 contained in the IC 106 and the corresponding conducted signal receiver 128 contained in the interface subsystem 104. According to an embodiment, substantially transparent z-axis conductors may be present throughout the transmissive layer 206. Alternatively, z-axis conductive material may be included in the layer 206 at locations corresponding to conducted signal pads and omitted from the optical transmission layer 206 at locations aligned to optical transmitters 110, 116 and receivers 114, 112. Alternatively, conducted signal interconnections may be made using wire-bonds or other conventional technology.

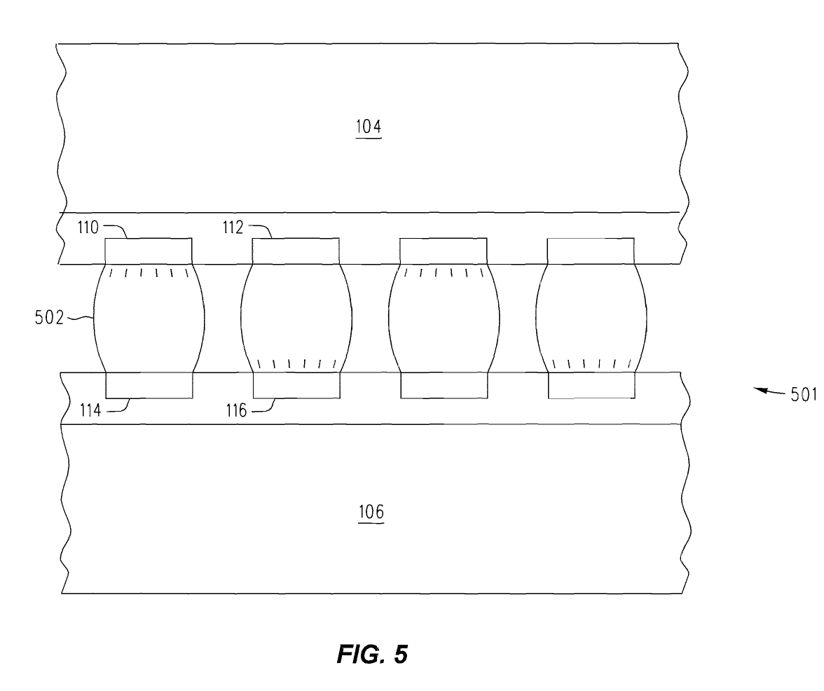

According to an embodiment illustrated in FIG. 5, the IC 106 may be connected to the optical interface subsystem 104 using a technology similar to flip-chip bonding. Instead of or in addition to using solder bumps or balls for conducted and mechanical coupling, balls of optical-quality adhesive, such as for example a hot-melt adhesive, may be used to form light-carrying interfaces. FIG. 5 is a partial cross-sectional diagram of an optical interface 501 according to an embodiment. The Interconnect system 501 is comparable to the interconnect system 201 of FIG. 2, except that interconnect system 501 includes light-transmissive connection balls 502 instead of a continuous light transmissive layer 206. According to an embodiment, the light-transmissive balls 502 may be deposited over the optical transmitters 116 and optical receivers 114 of the IC 106, and then the IC 106 may be placed on the optical interface subsystem 104 such that the light-transmissive balls 502 are in alignment with the corresponding optical receivers 112 and optical transmitters 110 of the optical interface subsystem 104. The light-transmissive balls 502 may then be heated to a softening temperature at which the light-transmissive balls melt or soften and form light transmission paths between the IC 106 and the optical interface subsystem 104. For bonding pads that need to be conductively coupled such as power and ground pads, solder balls or adhesive balls loaded with conductive material may be used to form conductive couplings.

According to an embodiment, light-transmissive balls 502 may be formed to provide light-guiding functionality. One approach to providing light guiding is to select a material for the light-transmissive balls having an index of refraction such that at least some rays from the optical transmitter 110, 116 that intersect the wall of the ball are reflected, such as by total internal reflection. Another approach is to select a material or set of materials that forms a reflective structure at the fluid-light transmissive ball interface.

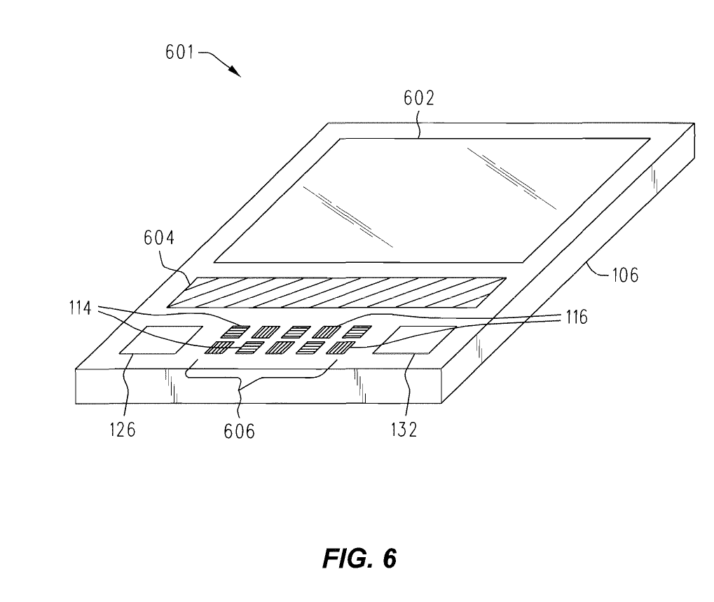

According to various embodiments, the optical interconnection approach taught herein may be applied to a variety of applications, including but not limited to microprocessors, ASICs, gate arrays, FPGAs, RAM, ROM, Flash memory, mixed-signal devices, display devices, etc. FIG. 6 illustrates an exemplary embodiment for interconnecting an image sensor array, such as a CMOS image sensor for digital camera applications.

As shown in FIG. 6, a CMOS sensor 601 is formed as an integrated circuit 106. A sensor array 602 comprises optical filters and integrated devices forming an array of detectors corresponding to pixel capture locations when the sensor array is aligned to a conjugate image plane. The sensor array 602 receives light at each element and converts a portion of the received light to electrical signals proportional to the intensity of the received light. Read-out and control logic 604 is used to control the sensor array 602. Power and ground pads 126 and 132 provide power for running the IC 106, each of the pads forming a conducted signal channel. An array 606 of optical signal receivers 114 and transmitters 116 made according to the foregoing teachings form a data interface to a host system such as a digital camera or camera phone.

From the foregoing it will be appreciated that, although specific embodiments of the invention have been described herein for purposes of illustration, various modifications may be made without deviating from the spirit and scope of the invention, which shall be limited only by the claims.

What is claimed is:

1. An electronic device having an optical interface comprising:
an integrated circuit;
a photo receiver disposed on the integrated circuit and operable to receive a first optical signal corresponding to a first data signal; and
an organic light-emitting-diode (OLED) disposed on the integrated circuit and operable to emit a second optical signal corresponding to a second data signal.

2. The electronic device having an optical interface of claim 1 further comprising circuitry operable to convert the first optical signal to the corresponding first data signal, generate the second data signal responsive to the first data signal, and drive the OLED according to data carried by the second data signal.

3. The electronic device having an optical interface of claim 1 wherein the integrated circuit is further operable to process computer instructions corresponding to the first data signal and responsively generate the second data signal.

4. The electronic device having an optical interface of claim 1 wherein the photo receiver includes at least one selected from the group consisting of a photo-diode, a photo-transistor, a photo-conductor, a photo-resistor, a non-linear optical device, and a non-linear organic optical device.

5. The electronic device having an optical interface of claim 1 wherein the photo receiver includes a printed portion.

6. The electronic device having an optical interface of claim 1 wherein the photo receiver includes a portion printed by a direct-write technology.

7. The electronic device having an optical interface of claim 1 wherein the OLED includes a printed portion.

8. The electronic device having an optical interface of claim 1 wherein the OLED includes a portion printed by a direct-write technology.

9. The electronic device having an optical interface of claim 1 further comprising an electrically conductive pad operable to receive a conducted signal.

10. The electronic device having an optical interface of claim 1 further comprising a conductive pad operable to receive a conducted signal comprising at least one selected from the group consisting of a DC positive voltage, an electrical ground, a DC negative voltage, an AC voltage, a digital data signal, a digital address, a digital data instruction, an analog data signal, an enable signal, and a latch signal.

11. The electronic device having an optical interface of claim 1 further comprising a light transmissive layer configured to couple at least one of the photo receiver and the OLED to an electronic system.

12. The electronic device having an optical interface of claim 1 further comprising a light transmissive adhesive configured to couple at least one of the photo receiver and the OLED to an electronic system and further configured to mechanically couple the integrated circuit to the electronic system.

13. The electronic device having an optical interface of claim 1 further comprising:
an electrically conductive pad operable to receive a conducted electrical signal;
a light transmissive layer configured to couple at least one of the photoreceiver and the OLED to an electronic system; and
a region of anisotropically conductive material configured to electrically couple the conductive pad to the electronic system.

14. The electronic device having an optical interface of claim 1 further comprising a light transmissive connection ball configured to couple at least one of the photo receiver and the OLED to a corresponding optical interface member of an electronic system.

15. The electronic device having an optical interface of claim 1 further comprising:
light transmissive connection balls configured to respectively couple the photo receiver and the OLED to a corresponding optical interface member of an electronic system;
an electrically conductive pad operable to receive a conducted signal; and
a solder ball configured to couple the conducted signal to the conductive pad.

16. The electronic device having an optical interface of claim 1 further comprising:
a mask having an aperture configured to isolate at least one of the first and second optical signals from other optical signals.

17. The electronic device having an optical interface of claim 1 wherein at least one of the first and the second optical signal includes data encoded according to at least one selected from the group consisting of amplitude modulated, frequency modulated, wavelength modulated, phase-shift-key modulated, return-to-zero modulated, non-return-to-zero modulated, half-duplex, full-duplex, spread-spectrum, direct sequence-spread-spectrum, and frequency-hopping-spread-spectrum.

18. The electronic device having an optical interface of claim 1 further comprising:
a power trace;
a ground trace;
a direct coupling between the OLED and one of the power and ground trace; and
a modulatable coupling between the OLED and the other of the power and ground trace.

19. The electronic device having an optical interface of claim 1 further comprising:
a bi-directional data trace;
a switching circuit coupled to the bi-directional data trace and operable to receive a received signal corresponding to the first data signal from the photo receiver and operatively couple the received signal to the bi-directional data trace and to receive a transmission signal corresponding to the second data signal from the bi-directional data trace and operatively couple the transmission signal to the OLED.

20. An interface subsystem for providing an optical interface to an integrated circuit comprising:
a body configured to couple to an integrated circuit;
an organic light-emitting diode (OLED) disposed on the body and operable to emit a first optical signal corresponding to a first data signal; and
a photo receiver disposed on the body and operable to receive a second optical signal corresponding to a second data signal.

21. The interface subsystem of claim 20 wherein the photo receiver includes a printed portion.

22. The interface subsystem of claim 20 wherein the photo receiver includes a portion printed by a direct-write technology.

23. The interface subsystem of claim 20 wherein the OLED includes a printed portion.

24. The interface subsystem of claim 20 wherein the OLED includes a portion printed by a direct-write technology.

25. The interface subsystem of claim 20 wherein the body comprises at least one selected from the group consisting of a printed circuit board, a printed wiring assembly, an integrated circuit, a chip carrier configured for mounting on a printed circuit board, and an integrated circuit package substrate.

26. The interface subsystem of claim 20 further comprising an interface to system circuitry.

27. The interface subsystem of claim 20 wherein the body is an integrated portion of a system circuit.

28. The interface subsystem of claim 20 further comprising an interface to system circuitry, the interface to system circuitry including at least one selected from the group consisting of USB, Firewire, IEEE 1284, PCI, PCMCIA, SmartMedia, Compact Flash, MMC, SD, SCSI, IRdA, Bluetooth, Zigbee, IEEE 802.11, Ethernet, and Fibre Channel.

29. The interface subsystem of claim 20 further comprising:
a first circuit operable to convert the first data signal to an energization signal and drive the OLED according to the energization signal; and
a second circuit operable to convert the second optical signal to the corresponding second data signal.

30. The interface subsystem of claim 20 further comprising circuitry operable to drive the OLED to emit a first optical signal comprising data encoded according to at least one selected from the group consisting of amplitude modulated, frequency modulated, wavelength modulated, phase-shift-key modulated, return-to-zero modulated, non-return-to-zero modulated, half-duplex, full-duplex, spread-spectrum, direct sequence-spread-spectrum, and frequency-hopping-spread-spectrum.

31. The interface subsystem of claim 20 further comprising an electrically conductive pad operable to transmit a first conducted signal.

32. An integrated circuit having an optical interface comprising:
an integrated circuit having a surface;
plurality of spaced-apart light emitters on the surface; and
a first plurality of light detectors on the surface interdigitated with the plurality of light emitters.

33. The integrated circuit having an optical interface of claim 32 further comprising a second plurality of light detectors operable to receive an image; and wherein the plurality of spaced apart light emitters and the first plurality of light detectors are operable to cooperate to transmit the received image to an electronic system.

34. The integrated circuit having an optical interface of claim 32 further comprising a second plurality of light detectors operable to receive an image, the second array of light detectors being selected from the group consisting of charge-coupled devices and complementary metal oxide semiconductor devices.

35. An electronic system comprising:
an interface subsystem for providing an optical interface to an integrated circuit, the interface subsystem comprising;
a body configured to couple to an integrated circuit,
a first light emitter disposed on the body and operable to emit a first optical signal corresponding to a first data signal, and
a first photo receiver disposed on the body and operable to receive a second optical signal corresponding to a second data signal; and
coupled to the body, an electronic device having an optical interface, the electronic device comprising;
an integrated circuit;
a second photo receiver disposed on the integrated circuit and operable to receive the first optical signal corresponding to the first data signal, and
a second light emitter disposed on the integrated circuit and operable to emit the second optical signal corresponding to the second data signal;
wherein at least one of the first and second light emitters includes an organic light-emitting diode (OLED).

36. The electronic system of claim 35 wherein the body and integrated circuit are coupled to provide optical alignment between the first light emitter and second photo receiver and between the first photo receiver and the second light emitter.

37. A method comprising:
transmitting a first light signal with an OLED disposed on an integrated circuit; and
receiving the first light signal with a first optical receiver disposed on a substrate.

38. The method of claim 37, further comprising:
transmitting a second light signal with a light emitter disposed on the substrate; and
receiving the second light signal with a second optical receiver disposed on the integrated circuit.
